(19) United States
(12) Patent Application Publication
(10) Pub. No.: US 2005/0243420 A1
(43) Pub. Date: Nov. 3, 2005

(54) Method of producing reflective design on a substrate and apparatus

(75) Inventor: Michael Robert Collier, Denver, CO (US)

Correspondence Address: LAW OFFICE OF DALE B. HALLING, LLC, 655 SOUTHPOINTE COURT, SUITE 100, COLORADO SPRINGS, CO, 80906, US

(73) Assignee: Harmony Fastening Systems, Inc.

(21) Appl. No.: 11/117,053

(22) Filed: Apr. 28, 2005

Related U.S. Application Data
(60) Provisional application No. 60/567,637, filed on May 3, 2004.

(51) Int. Cl. G02B 5/128

(52) U.S. Cl. 359/536

(57) ABSTRACT

A method of producing a reflective design on a textile includes the steps of applying a reflective film to a textile. A laser is focused on the reflective film to produce a design on a surface of the reflective film.

### RELATED APPLICATIONS

The present invention claims priority on provisional patent application, Ser. No. 60/567,637, filed on May 3, 2004, entitled “Laser Engraving Images and Text on a Surface of a Photo-Reflective Material”.

### FIELD OF THE INVENTION

The present invention relates generally to the field of reflective designs and more particularly to a method of producing a reflective design on a substrate.

### BACKGROUND OF THE INVENTION

Garments for running, cycling, footwear, hats, backpacks, jackets, pet collars, and leashes all utilize photo-reflective material for the purpose of increasing the wearer's visibility and safety after dark. This material is typically attached to the garment by sewing or is adhered using heat activated adhesive. One problem with the addition of reflective material is that it typically reduces the aesthetics of the garment in daylight. As a result, many consumers are unwilling to take advantage of the beneficial features provided by reflective materials on garments.

Thus there exists a need for more visually appealing garments that have light reflecting material.

### SUMMARY OF INVENTION

A method of producing a reflective design on a textile that overcomes these and other problems includes the steps of applying a reflective film to a textile. A laser is focused on the reflective film to produce a design on a surface of the reflective film. The laser may be focused in a dot pattern on the reflective film. A graphical design may be produced. Pressure and heat may be applied to the textile. A textile that has a high thread count may be selected. A textile with a thin yarn may be selected. The reflective film colored with an ink may be selected.

In one embodiment, a textile with a reflective design has a reflective film on a portion of the textile. A laser pattern is formed on a surface of the reflective film. This pattern forms the reflective design. An ink is placed on the reflective film. The piece of textile is not made of nylon. The piece of textile may have a high thread count. The reflective design may have duotones. The laser pattern may include a portion that is a series of non-connected dots. Adhesive may be between the textile and the reflective film.

In one embodiment, a method of producing a reflective design on a textile includes the steps of selecting a substrate. A reflective film is laminated onto the substrate. A laser beam is focused onto the reflective film to form a pattern on a surface of the reflective film. A textile is selected as the substrate. A surface of the substrate is heated. An ink may be applied to the reflective surface. The ink may be an alcohol based ink. A dot pattern may be created to form the design.

### BRIEF DESCRIPTION OF THE DRAWINGS

FIG. 1 is a block diagram of a system for producing a reflective design on a textile in accordance with one embodiment of the invention;

FIG. 2 is an example of a reflective design on a textile in accordance with one embodiment of the invention; and

FIG. 3 is a flow chart of the steps used in producing a reflective design on a textile in accordance with one embodiment of the invention.

### DETAILED DESCRIPTION OF THE DRAWINGS

The present invention increases the aesthetic appeal of garments that have a reflective film. The reflective film is patterned on its surface with a laser. The pattern can be text or graphics. The pattern is on the surface of the reflective film and does not extend visibly below the surface. In certain embodiments, the pattern can take on duotone attributes. The patterned area commonly retains some of its reflective attributes after being patterned.

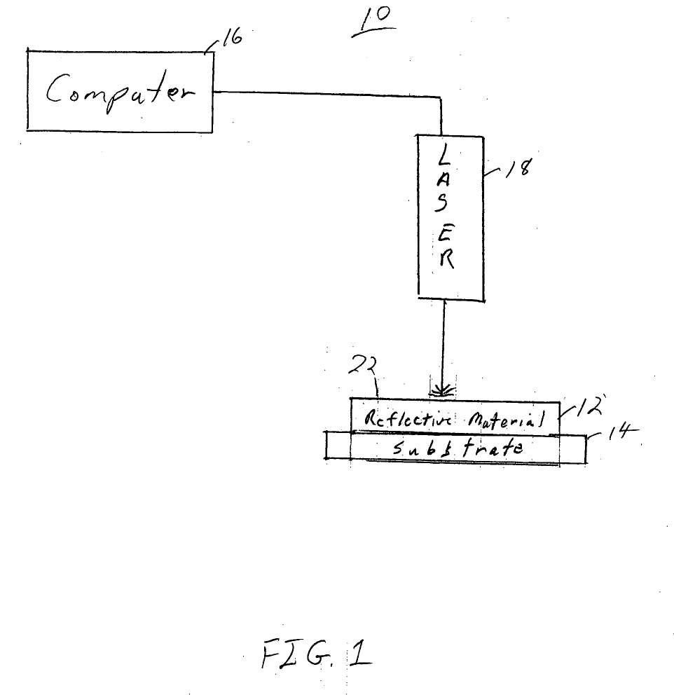

FIG. 1 is a block diagram of a system 10 for producing a reflective design on a textile in accordance with one embodiment of the invention. A reflective film 12 is laminated or sewn to a substrate 14. In one embodiment, the substrate 14 is a textile product. A pattern or design is put into a computer 16. The computer 16 directs a laser 18 and associated optics to focus the laser beam 20 onto a surface 22 of the reflective film 12. It is thought that the laser beam partially ablates and partially carbonizes the surface of the reflective material. The reflective film 12 has tiny glass beads reflectors embedded in a polymer. Where the surface is carbonized the surface looks black and the glass beads are no longer able to enhance the reflection of light. Note that the appearance of the finished product is substantially increased by only having the surface of the reflective film patterned by the laser. To achieve adequate results, the laser intensity and dwell on a particular spot need to be precisely set or the laser may not sufficiently mark the reflective film or it may burn through the reflective film. Ideally, the surface is patterned so lightly that to a user's touch that the laser patterned area appears to be at essentially the same level as the rest of the front surface of the reflective film. Note that the pattern may be made by a number of dots where the laser has been focused on the surface of the reflective material. The density of the dots can be used to create shades of grey. On a colored reflective film, variations in dot density results in duotones.

In one embodiment, the laser beam is positioned at different spots on a stationary reflective film. Conversely, it is possible to move the reflective film and have the laser beam be stationary.

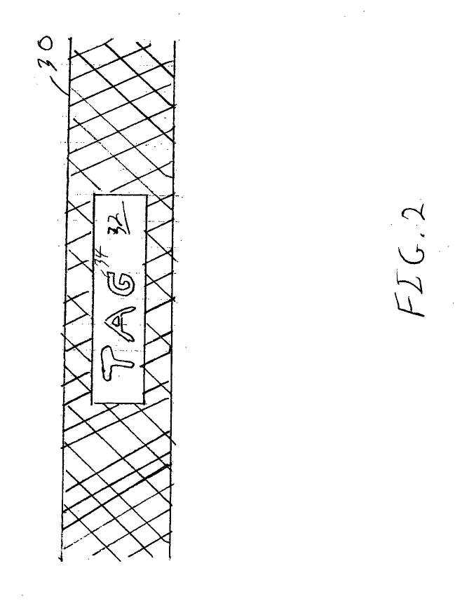

FIG. 2 is an example of a reflective design on a textile in accordance with one embodiment of the invention. A textile 30 has a reflective film 32 laminated to the textile 30. Commonly, heat activated adhesive is used to laminate the reflective film 32 to the textile 30. The reflective film 32 may be laminated by sonic welding, RF welding or any other of the well known laminating techniques. A design 34 is fashioned by a laser onto the surface of the reflective film 32. The appearance of the overall product can be enhanced by selecting a textile 30 that has smooth surface commonly associated with a higher thread count and thinner yarn. For some applications like collars, it is helpful if the webbing of the textile is braided at approximately 45 degrees to the length of the collar. When this is done, bending the collar does not result in bumps from the textile in the reflective film. Before the reflective film 32 is laminated to the textile 30 the textile may be subjected to heat and pressure. This further tightens the weave of polymer based textiles. As a result, the reflective film sits flat on the textile rather than having a bumpy looking surface. In one embodiment, the reflective film is treated with an ink before it is patterned with the laser. The ink may be an alcohol based ink.

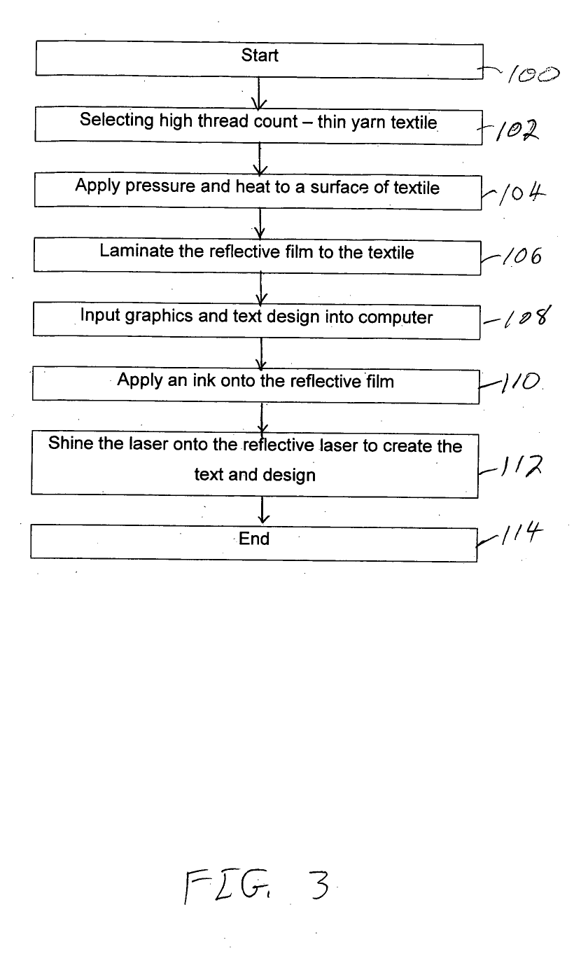

FIG. 3 is a flow chart of the steps used in producing a reflective design on a textile in accordance with one embodiment of the invention. The process starts, at step 100. A high thread count, thin yarn textile at step 102. In one embodiment, the textile is a polymer based textile. In another embodiment, the textile is a polymer based textile, but not nylon. Pressure and heat are applied to a surface of the textile at step 104. In one embodiment, only heat is applied to the surface of the textile. The reflective film is laminated to the textile at step 106. The graphics and text design is input into a computer at step 108. An ink may be applied to the reflective film at step 110. At step 1 12, the laser is focused onto the reflective film with the appropriate power and dwell settings to create the design, which ends the process at step 114.

Thus there has been described a system and method for producing a reflective design on a substrate that results in more visually appealing garments that have light reflecting material.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A method of producing a reflective design on a textile, comprising the steps of:
a) applying a reflective film to a textile; and
b) focusing a laser on the reflective film to produce a design on a surface of the reflective film.

2. The method of claim 1, wherein the step (b) further includes the step of:
b1) shining the laser in a dot pattern on the reflective film.

3. The method of claim 1, wherein step (b) further includes the step of:
b1) producing a graphical design.

4. The method of claim 1, wherein step (a) further includes the step of:
a1) heating and applying pressure to the textile.

5. The method of claim 1, further including the step of:
a2) selecting a textile having a high thread count.

6. The method of claim 5, further including the step of:
a3) selecting a textile with a thin yarn.

7. The method of claim 1, wherein step (a) further includes the step of:
a1) treating the reflective film with an ink.

8. A textile having a reflective design, comprising:
a piece of a textile;
a reflective film placed on a portion of the textile; and
a laser pattern on a surface of the reflective film that forms the reflective design.

9. The textile having a reflective design of claim 8, further including an ink on the reflective film.

10. The textile having a reflective design of claim 8, wherein the piece of textile is not made of nylon.

11. The textile having a reflective design of claim 10, wherein the piece of textile has a high thread count.

12. The textile having a reflective design of claim 8, wherein the reflective design has duotones.

13. The textile having a reflective design of claim 12, wherein the laser pattern includes a portion that is a series of non-connected dots.

14. The textile having a reflective design of claim 13, further including a adhesive between the textile and the reflective film.

15. A method of producing a reflective design on a textile, comprising the steps of:
a) selecting a substrate;
b) laminating a reflective film onto the substrate; and
c) directing a laser beam onto the reflective film to form a pattern on a surface of the reflective film.

16. The method of claim 15, wherein step (a) includes the step of:
a1) selecting a textile as the substrate.

17. The method of claim 16, further including the step of:
a2) heating a surface of the substrate.

18. The method of claim (b) further including the step of:
b1) applying an ink to the reflective surface.

19. The method of claim 18, wherein step (b1) includes selecting an alcohol based ink.

20. The method of claim 15, wherein step (c) further includes the step of creating a dot pattern.
